(19) United States
(12) Patent Application Publication
(10) Pub. No.: US 2012/0103351 A1
(43) Pub. Date: May 3, 2012

(54) Applicator

(75) Inventors: Gary Fallon, London (GB); Gerhard Le Roux, Cape Town (ZA)

(73) Assignee: British American Tobacco (Investments) Limited, London (GB)

(21) Appl. No.: 13/381,335

(22) PCT Filed: Jun. 30, 2010
(86) PCT No.: PCT/EP10/59267

§ 371 Date: Dec. 28, 2011

(30) Foreign Application Priority Data
Jun. 30, 2009 (GB) 0911260.8

(51) Int. Cl. A24C 5/00; B31C 99/00; B05D 1/12; B05C 19/04; B05C 5/02

(52) U.S. Cl. 131/284; 118/308; 118/630; 118/324; 118/311; 427/180; 493/39

(57) ABSTRACT

An applicator operable to apply an additive to a smoking article wrapping material comprises a conveyance mechanism for conveying the wrapping material along a path and an inlet to receive a gaseous flow for entraining additive, the applicator being configured such that in use, additive entrained in the gaseous flow is caused to be diverted towards the wrapping material.

### FIELD OF THE INVENTION

This invention relates to an applicator for applying an additive such as charcoal to a smoking article wrapping material, for example a cigarette filter plugwrap.

### BACKGROUND OF THE INVENTION

Smoking articles such as cigarettes are often provided with filters for filtering the smoke drawn from the cigarette by a smoker. Such filters usually comprise a plug of cellulose acetate tow wrapped with a paper plugwrap.

It is known to provide a cigarette having a filter including a charcoal additive. When the cigarette is smoked, certain elements are removed from the smoke by the charcoal.

It has been proposed to apply the charcoal to a filter plugwrap by lining a ribbon of plugwrap with glue and subsequently dropping the charcoal onto the glue-lined paper under gravity.

A disadvantage of this “gravity feed” arrangement is that the amount of charcoal which can be applied per second is limited, especially if the plugwrap is to be conveyed at high speed.

A further disadvantage of this approach is that the charcoal would bounce on the paper ribbon due to the elasticity of the paper, even when glue is applied thereto, thus causing the charcoal granules to become disarranged and unevenly distributed on the ribbon. As a result, filtration properties of the eventual filters may vary from filter to filter.

### SUMMARY OF THE INVENTION

The present invention provides an alternative approach for applying an additive such as charcoal to a smoking article wrapping material.

As used herein, the term “smoking article” includes smokeable products such as cigarettes, cigars and cigarillos whether based on tobacco, tobacco derivatives, expanded tobacco, reconstituted tobacco or tobacco substitutes and also heat-not-burn products.

A smoking article preferably comprises one or more inner and/or outer layers of wrapping material(s), wrapped at least partially around the smoking article or part thereof.

A smoking article preferably comprises a tobacco rod wrapped with a wrapping material in the form of a cigarette paper. The smoking article may have a filter and the filter may be wrapped with another wrapping material such as a filter plugwrap paper. A further wrapping material, known as a tipping paper, is wrapped around the paper wrapped filter and the paper wrapped rod of smokeable material to join them together.

The term “smoking article wrapping material” used herein includes all materials used to wrap smoking articles or to wrap components of smoking articles such as smoking article filters. Thus, the term includes for example porous and non-porous filter plugwrap materials, cigarette papers and tipping papers.

The present invention provides an applicator operable to apply an additive to a smoking article wrapping material, comprising a conveyance mechanism for conveying the wrapping material along a path and an inlet to receive a gaseous flow for entraining additive, the applicator being configured such that in use, additive entrained in the gaseous flow is caused to be diverted towards the wrapping material.

In this way, the additive may be applied to the wrapping material at a rate dependent on the speed of additive entrained in the gaseous flow. Thus, even where the wrapping material is conveyed at speed, a high loading of additive on the wrapper may be achieved by generating a suitably fast gaseous flow.

The gaseous flow may be directed such that the gaseous flow or a substantial part thereof does not impinge on the wrapper. In this way the additive may be applied to the wrapping material without causing the gaseous flow to substantially blow additive off the wrapping material and without causing turbulence which would otherwise occur at the point of impact between the gaseous flow and the wrapper. Thus, the additive may be applied in a controlled manner and with an even distribution.

Preferably the wrapping material follows a substantially straight path through the application region in which the additive is applied to the wrapping material. Further preferably, the applicator may have a gaseous flow directing member configured to direct the gaseous flow into the application region in a direction substantially parallel to the path of the wrapping material through the application region.

The term “substantially parallel” as used herein is not intended to be limited to the strict geometric meaning of the term “parallel” and instead should be understood to also relate to directions extending in similar directions, for example directions having angles of a few, or even ten or fifteen degrees between them.

The additive may be applied from below the wrapper. In this way, the additive will not be caused to bounce off the wrapper under gravity, thus allowing an improved distribution of additive on the wrapper.

An even distribution of additive on the wrapping material allows the eventual filters to be conveniently manufactured with uniform filtration properties so that the smoker is provided with a consistent smoking experience from cigarette to cigarette. Preferably the additive is a granular additive such as granular activated charcoal.

The applicator may further comprise a charging unit for electrostatically charging the wrapping material so as to provide an electrostatic force acting on additive entrained in the gaseous flow which causes the additive to be diverted towards the wrapping material.

In order that the invention may be more fully understood, an embodiment thereof will now be described by way of illustrative example with reference to the accompanying drawings, in which:

### BRIEF DESCRIPTION OF THE DRAWINGS

FIG. 1 shows a charcoal applicator.

FIG. 2 is a perspective view of the charcoal applicator with the conveyance mechanism and paper ribbon removed.

FIG. 3 shows the nozzle of the charcoal applicator in perspective and cutaway views.

FIG. 4 shows an exploded perspective view of the applicator.

FIG. 5 shows a cross sectional view, a side view and a top view of the applicator.

FIG. 6 shows the path of granules through an intermediate chamber of the applicator.

FIG. 7 illustrates the paths of the wrapping material, gaseous flow and charcoal additive in the application chamber of the applicator.

### DETAILED DESCRIPTION

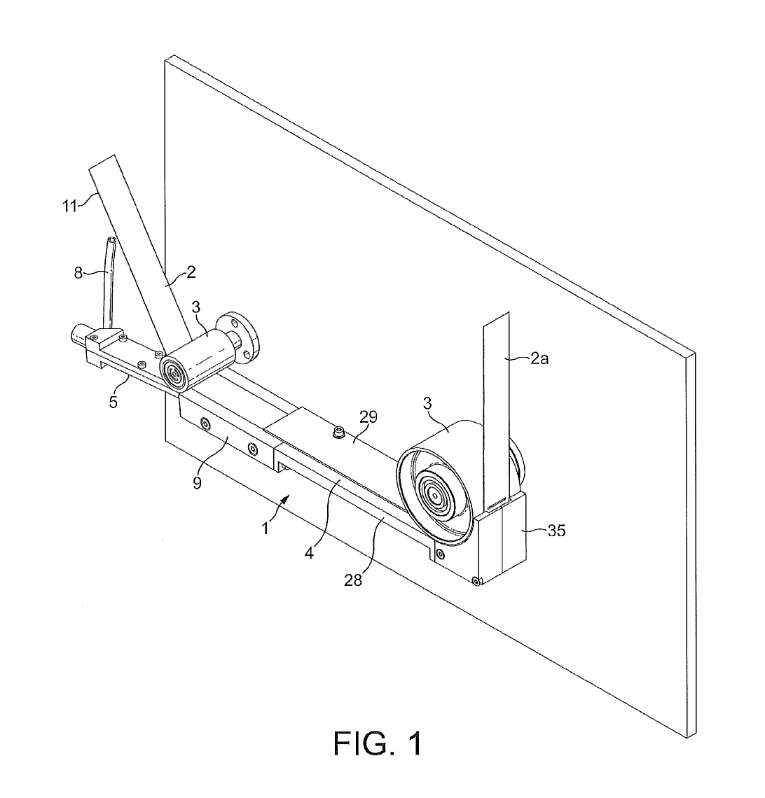

FIGS. 1-5 shows a charcoal applicator 1 for applying a granular additive in the form of charcoal to a cigarette wrapping material in the form of a ribbon of plugwrap paper 2. As shown, applicator 1 comprises a conveyance mechanism having a plurality of rollers 3 for conveying the ribbon 2 through an application chamber 4, where charcoal granules are applied thereto. The charcoal loaded paper 2a is received from the applicator 1 by a filter rod maker (not shown), where it is wrapped around an elongate rod of cellulose acetate tow which is subsequently cut to form filter rod segments.

Referring to FIGS. 1-5, applicator 1 comprises a nozzle 5 having a venturi section 6 configured to receive compressed air through air inlet 7 and to suck granules of charcoal from a charcoal supply (not shown) through a charcoal inlet pipe 8 and into the air flow. As shown, the air having the charcoal entrained therein passes from the nozzle 5 through intermediate chamber 9 and into application chamber 4, where the charcoal is applied to the paper 2.

The intermediate chamber 9 and application chamber 4 are arranged such that the flow of air and charcoal is directed substantially parallel to the direction of motion of the ribbon upon entering the application chamber 4. In this way the air flow does not impact directly on the ribbon, which would otherwise tend to blow off charcoal from the paper and cause turbulence around the point of impact.

The flow of charcoal is separated from the flow of air in the application chamber 4 due to electrostatic forces between the charcoal and the paper. The applicator 1 has an electrostatic charging unit 10 for charging the paper 2 as it passes through the application chamber 4. In this way, the charcoal entrained in the flow of air entering the application chamber 4 is electrostatically attracted towards the underside of the ribbon 2, where it adheres to an adhesive applied to the lower surface 11 thereof.

Thus, the charcoal is applied from below the paper ribbon 2 and adheres to its lower surface 11. In this way the charcoal will not be caused to bounce under gravity on the ribbon and a homogeneous distribution of charcoal can be obtained along the length of the ribbon. Thus, the segments of charcoal loaded paper comprised in the filters of each eventual cigarette will have very similar amounts and distributions of charcoal. Thus, a uniform smoking experience can be provided to eventual consumers from cigarette to cigarette.

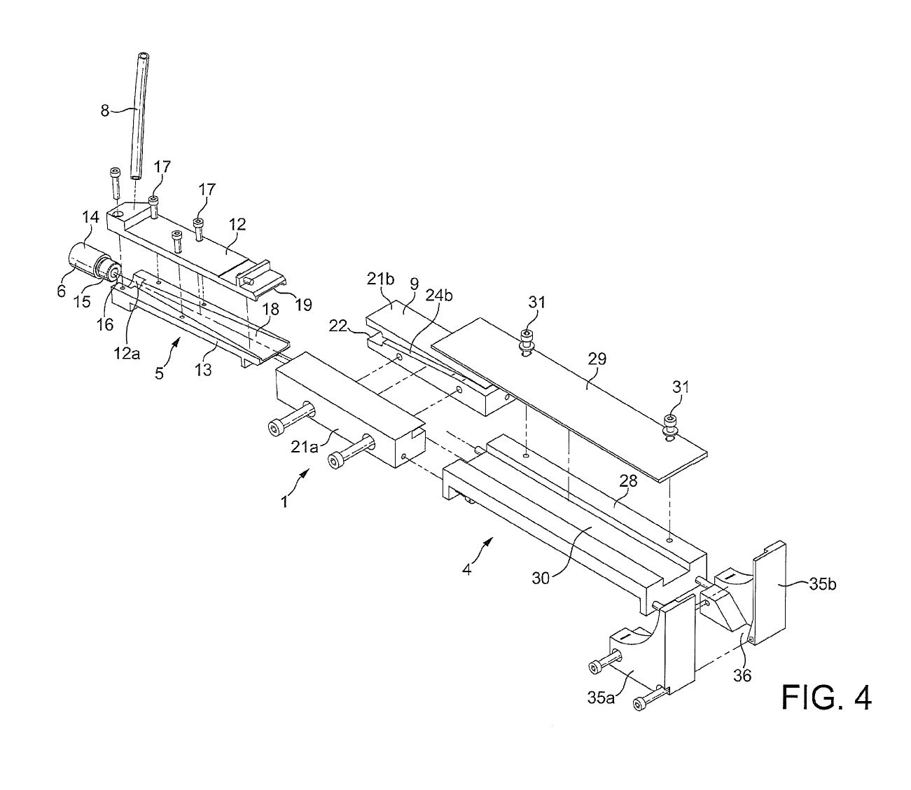

FIG. 4 shows an exploded perspective view of the applicator 1 and illustrates, inter alia, the components of the nozzle 5. As shown, the nozzle 5 includes venturi section 6, a nozzle top 12, a nozzle bottom 13 and a charcoal inlet pipe 8. The inlet pipe 8 preferably has an inner diameter of about 4 mm. The venturi section 6 comprises an air inlet 7, a cylindrical body 14 and a collar 15 which is held in place between the nozzle top 11 and bottom 12. A bore hole 16 extends longitudinally through the venturi section 6 and is tapered within the collar 15. The throat of the venturi preferably has a diameter of about 6 mm. The charcoal inlet pipe 8 meets the venturi section at a hole (not shown) provided in the periphery of the collar, which leads to the side of the tapered bore through the collar 15. In use, the inlet 7 is connected to a source of compressed air, which generates an air flow which passes through the bore 16 and becomes constricted in the tapered region in the collar 15, causing the air pressure to drop in the tapered region due to the Venturi effect. The reduced pressure in the tapered section causes the charcoal to be sucked through the charcoal inlet pipe 8 into the venturi section 6, where it is swept into the flow of air passing through the bore hole 16. In this way, the charcoal becomes entrained in the airflow expelled from the venturi section 6.

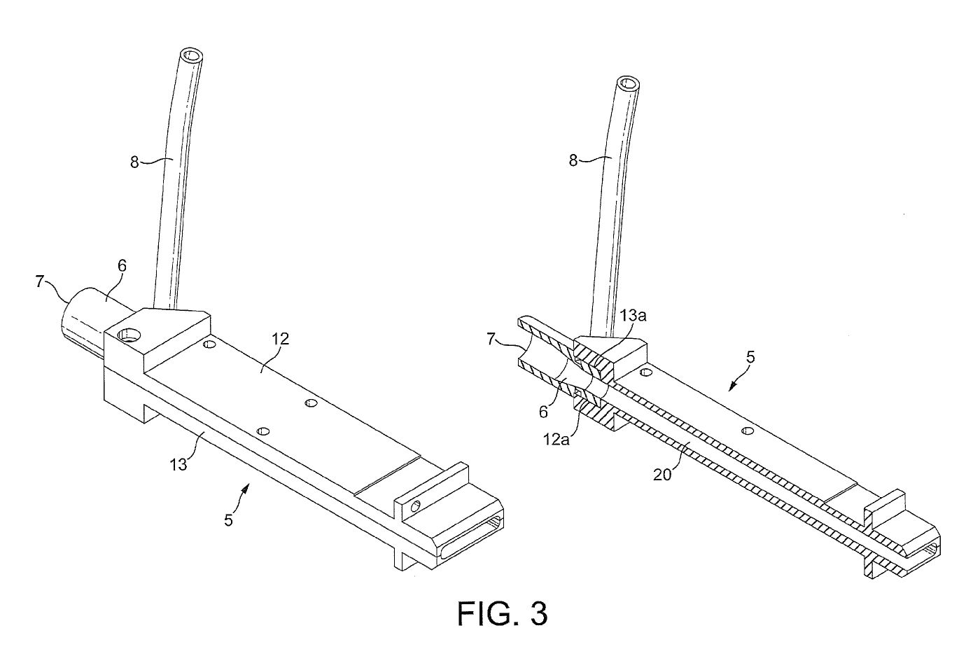

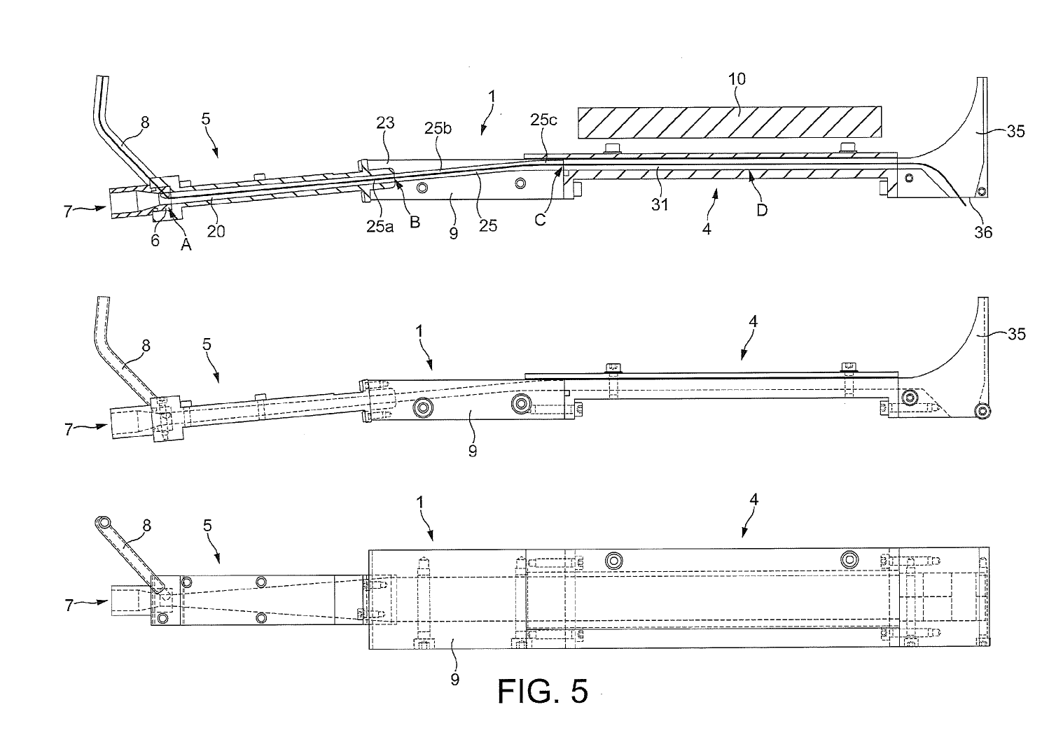

Referring to FIGS. 3 and 4, the nozzle top 12 and bottom 13 are fixed together using bolts 17 and have grooves 12a, 13a therein which when assembled define a receiving port in which the collar 15 of the venturi section 6 is held in place. Nozzle top 12 and bottom 13 also have co-terminus elongate grooves 18, 19 extending therethrough which together define a channel 20 for the flow of air and charcoal, which widens laterally from the outlet of the venturi section 6 to the outlet of the nozzle 5. As shown in FIG. 5, the nozzle 5 and channel 20 therein are arranged at an angle to the horizontal, preferably approximately 5°.

Referring to FIGS. 4 and 5, intermediate chamber 9 comprises first and second lateral sections 21a, 21b having grooves 22 which when assembled define a receiving port 23 for the nozzle 5. The sections 21a, 21b also each have elongate grooves 24a, 24b which together define a channel 25 for the flow of air and charcoal from the nozzle to the application chamber 4.

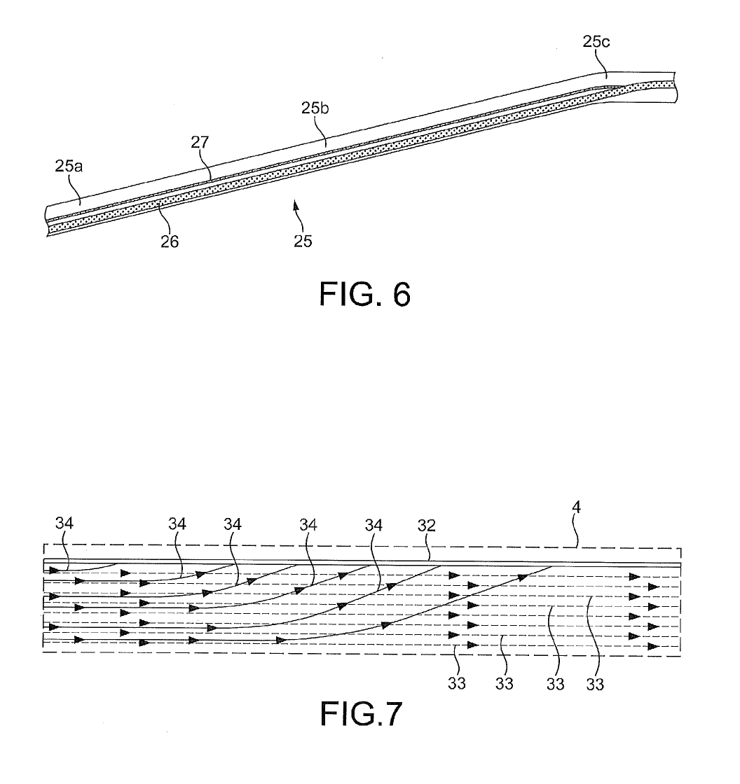

FIG. 6 shows the channel 25 in more detail. In the inlet region 25a and the centre region 25b of the channel 25, the channel is arranged parallel to the channel 20 of the nozzle, ie: at an angle of approximately 5° to the horizontal. However, in the outlet region 25c, the channel 25 curves and becomes horizontal so that the flow of air and charcoal is directed horizontally on entry into the application chamber 4.

As the granules carried by the flow of air move through the nozzle 5 and through the inlet 25a and centre 25b regions of the intermediate chamber 9, finer particles will tend to travel in the centre of the air stream, while heavier particles will tend to travel closer to the bottom thereof. This distribution of granules is illustrated in FIG. 6, in which the thick line 26 illustrates the path of heavy/coarse particles while the thinner line 27 illustrates the path of light/fine particles. As shown, in the inlet region 25a and centre region 25b of the intermediate section 9, the path 26 of heavy/coarse particles is below that of the light/fine particles 27.

As shown, in the outlet region 25c the channel curves and becomes horizontal. As shown in FIG. 6, the light/fine particles moving through the section 25c stay approximately in the centre of the air stream, while the heavier/coarser particles, due to their inertia, maintain their original line of motion for a longer time before being deflected. Thus, the change in angle of the channel 25 in the outlet region 25c results in improved axial alignment between the flow of heavier/coarser particles and the flow of lighter/finer particles into the application chamber 4. Thus, a better mix of heavy and light particles is provided at the inlet of the application chamber 4, which assists in obtaining an even distribution of charcoal on the paper 2.

The channel 25 of the intermediate chamber 9 widens laterally in the region 25c, thereby causing the velocity of the airflow to reduce prior to leaving the chamber 9. This assists in preventing turbulence on entry to the application chamber 4.

Referring again to the exploded view of FIG. 4, the application chamber 4 comprises a body 28 and a cover plate 29, which serves as a guide for the paper ribbon 2. As shown, the body 28 has a channel 30 with a rectangular cross section extending therethrough. The cover plate 29 is bolted to the body 28 and to the intermediate chamber 9 with bolts 31.

As shown in FIG. 1, in use ribbon 2 passes under plate 29 and above body 28 and is conveyed therebetween. The ribbon 2 moves along a path through the application chamber 4 parallel to the lower surface of plate 29. The ribbon 2 is provided with an adhesive on a lower surface thereof, prior to being conveyed through the application chamber 4. Preferably, the adhesive is applied across approximately 50% of the width of the ribbon 2.

Referring to FIG. 5, the flow of air and charcoal is directed through the outlet of the intermediate chamber 9 into the application chamber 4 in a direction parallel to the path of the ribbon 2. The outlet of the intermediate chamber 9 is disposed just below the plane containing the ribbon path. The flow of air passes through the channel 30 along a path below and parallel to the path of the ribbon 2. Thus, the flow of air does not impinge directly on the wrapper, which would otherwise result in turbulence in the airflow at the point of airflow. Turbulence in the airflow carrying the charcoal granules makes achieving an even distribution of charcoal on the ribbon 2 more difficult and is therefore undesirable.

The gap between the flow of air and the lower surface of the paper 2 may be small enough such that air flowing in the periphery of the airflow may come into contact with the underside of the paper as the air current passes through the channel. As a result, even though the flow of air is not directed towards the wrapper, a small percentage, for example 1-5%, of the air flow may in fact contact the paper 2 as it passes through the application chamber, the remainder of the air flow passing through the chamber 6 without contacting the paper 2.

The air flow is however directed such that a substantial percentage of the air in the airflow entering the channel does not impinge on the ribbon 2 and instead passes through the chamber 4 without making contact with the wrapper. As used herein, the term “substantial percentage” includes percentages of for example 99%, 95%, 90%, 80% and 75%. Alternatively, all of the airflow entering the application chamber may pass through the channel without impinging on the paper.

As shown in FIG. 5, an electrostatic charging unit 10 is mounted above the application chamber 4 and is configured to provide an electrostatic charge to the ribbon 2. Electrostatic units for charging paper and other materials are well known per se and will not be described in detail here. Various ways of charging the paper will be evident to those skilled in the art. For example, the electrostatic charge may be transferred to the paper via the cover part 29, with which the paper may make glancing contact as it is conveyed. Alternatively, the paper may be pre-charged before it enters the application chamber 4. For convenience, it will be assumed in what follows that the electrostatic charging unit provides a positive charge to the ribbon 2, although a negative charge could alternatively be provided.

The positively charged ribbon 2 induces an electric polarisation in the charcoal granules entrained in the nearby air flow passing through the application chamber 4. That is, the charged ribbon causes the negative charges in the granules to become positioned slightly closer to the paper and the positive charges in the granules to become positioned slightly further away from the paper. Thus, although the overall electric charge of the granules remains neutral, the attractive Coulomb force on the negative charges due to the positively charged ribbon 2 is greater than the repulsive Coulomb force on the positive charges so that a net attractive force is exerted on the granules towards the ribbon 2.

Thus, an electrostatic force acts on the charcoal granules entrained in the flow of air which attracts the granules towards the ribbon 2. The path 32 of the ribbon, the pathlines of the airflow 33 and the path of the charcoal 34 through the application chamber 4 are illustrated in FIG. 7. As shown, the direction of airflow 33 is parallel to the path 32 of the ribbon. The paths of the charcoal are initially coincident with the airflow pathlines and parallel to the ribbon path 32 at the inlet of the application chamber 4. However, as the charcoal passes through the application chamber 4, it is electrostatically deflected along curved paths and thus diverted towards the underside of the ribbon 2, where it adheres to the adhesive applied thereon.

As shown in FIGS. 1-5, the applicator 1 has an exhaust section 35 to receive excess charcoal passing through the application chamber 4 which does not make contact with or adhere to the paper 2. The exhaust 35 is configured such that the cross section of the air channel is increased therein, thus causing the velocity of the air and charcoal to decrease before it leaves the exhaust through outlet 36. As shown in the exploded perspective view of FIG. 3, the exhaust 35 comprises first and second parts 35a, 35b attached to one another and to the application chamber 4.

The arrangement of the applicator 1, for example the dimensions of the air channels of the nozzle 6, intermediate section 9 and application chamber 4 and the speed of the air flow into the nozzle 6 are chosen to ensure a smooth, laminar flow of air through the application chamber 4, thereby assisting in achieving an even distribution of charcoal on the ribbon 2. Table 1 below sets out the cross sectional area of the channel and the air velocity at the reference points A, B, C and D of the applicator shown in FIG. 5.

TABLE 1

| Reference point | Cross sectional area (mm²) | Air velocity (m/sec) |
|---|---|---|
| A | 28.27 | 36.5 |
| B | 86 | 12 |
| C | 110 | 9.38 |
| D | 121 | 8.5 |

Once charcoal has been applied to the ribbon 2 by the applicator 1, the charcoal loaded ribbon 2a is received from the applicator 1 by a filter rod maker (not shown), configured to wrap the ribbon around an elongate rod of cellulose acetate tow which is subsequently cut to form filter rod segments. Filter rod makers are known per se and will not be described in detail herein. The speed at which the paper 2 is conveyed through the applicator 1 is synchronised with the speed at which rods are manufactured, which may for example be for example in the range of 50 to 500 rod meters per minute and/or in the range of 125 to 4000 filter rods per minute. Preferably however, the rods are manufactured at a speed of 400 to 500 rod meters per minute and/or in the range of 1000 to 4000 filter rods per minute. The paper may be conveyed at a speed of between 0.83 and 8.33 meters per second and preferably at a speed of between about 2.5 and about 8.3 meters per second.

Preferably, charcoal passes into the application chamber 4 at a rate of about 150 to about 160 grams per second, although lower or higher flow rates are also envisaged. The applicator 1 may have a metering device (not shown) positioned before the inlet pipe 8 to control the rate of flow of charcoal into nozzle 5 and hence the rate of flow of charcoal into the application chamber 4. Higher flow rates may be achieved by using a larger inlet tube and a larger venturi diameter, for example.

Table 2 sets out theoretical (calculated) load values at different machine speeds. The term “load” refers to the mass of charcoal applied per unit length of wrapping material.

TABLE 2

| Machine Speed | Charcoal Load |
|---|---|
| (Meters/Minute) | (Grams/Meter) |
| 50 | 94.80 |
| 100 | 47.40 |
| 150 | 31.60 |
| 200 | 23.70 |
| 250 | 18.96 |
| 300 | 15.80 |
| 350 | 13.54 |
| 400 | 11.85 |
| 450 | 10.53 |
| 500 | 9.48 |

In these calculations, it assumed that charcoal flows into the inlet pipe 8 at a rate of 158 grams per second. It is also assumed that the glue is applied across 50% of the ribbon width and that 50% of the charcoal entering the application chamber 4 is deposited on the paper as a result. These assumptions are of course not intended to be limiting. In practice, the load may be different from the calculated values and will depend on, inter alia, the amount and type of adhesive used. However, the table illustrates the general trend of reduced charcoal loading at higher machine speeds due to the faster speed of the ribbon 2. In use, the machine speed may be set so that a desired charcoal load is achieved on the paper.

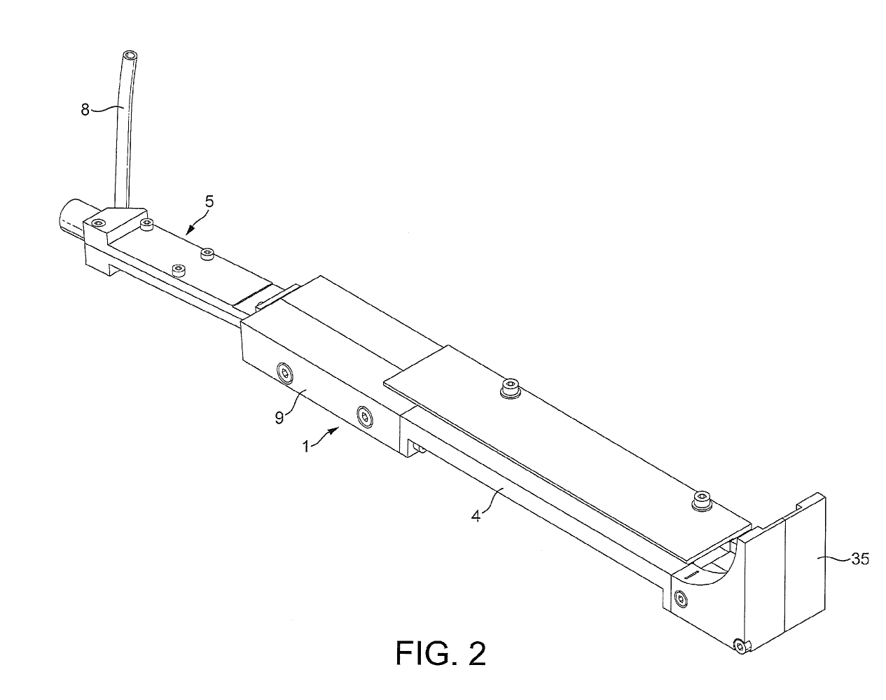

At low speeds, the load may also be less than shown in FIG. 2 due to a saturation effect where the layer of charcoal formed on the paper becomes thick enough so as to begin to prevent charcoal from adhering to the glue. It is estimated that when the layer of charcoal is approximately 2.5 mm thick, further charcoal will not adhere to the paper. For these reasons, the actual charcoal load may remain approximately constant for machine speeds below about 200 meters/minute.

It will be appreciated from the above that the applicator 1 can apply charcoal to the ribbon 2 at high speed and at high density, whilst maintaining an even distribution of charcoal along the ribbon. Thus, cigarette filter rods wrapped with charcoal loaded plugwrap may be manufactured at high speeds and with uniform properties from filter rod to filter rod.

Preferably, the charcoal granules used in the applicator 1 have a mesh size of between 30 and 70 US mesh. However, the granules may have a mesh size of between 12 and 80 US mesh.

The granules may, for example range in size from about 0.18 mm to about 1.68 mm and preferably range in size from 0.21 mm to 0.60 mm.

The charcoal may be vegetable based, for example coconut husk based. Example parameter values and ranges for coconut based charcoal material are provided below in Table 3:

TABLE 3

| Parameter | Value |
|---|---|
| Ash content | 2-4% |
| Apparent Bulk density | 0.46-0.60 gms/cc |
| Particle size distribution | 30-70 US mesh |
| Dust | <5 mg/25 cc |
| Activity CTC | 59%-69% |
| Activity N-Butane | 23.0%-27.0% |
| Ball pan hardness | >97% |

Many modifications and variations will be evident to those skilled in the art. For example, instead of charcoal, the additive may alternatively or in addition comprise another carbonaceous material or, for example a catalytic material. Preferably, however the additive comprises carbon. However, the additive may alternatively (or in addition) comprise, for example, a flavour additive, tobacco dust particles or reconstituted tobacco, or crystals such as menthol crystals.

Furthermore, instead of a ribbon of filter plugwrap material, the additive may be applied to another smoking article wrapping material, for example cigarette paper. The cigarette paper having additive applied thereto may in one example be received from the applicator by a cigarette maker (rather than a filter rod maker), the cigarette maker being configured to manufacture cigarettes by wrapping the cigarette paper around a rod of tobacco.

Still further, although the gaseous flow has been previously described as a flow of air, any suitable gas, for example oxygen or nitrogen, may be used.

Further, although the electrostatic charging unit has been described as charging the ribbon in order to provide an electrostatic force between the additive and the ribbon, alternatively or in addition the additive may be charged to provide the electrostatic force. Alternatively, or in addition, another element of the applicator 1 may be charged so as to provide or contribute to the electrostatic force which causes the additive to be diverted towards the wrapping material.

Further, instead of directing the gaseous flow parallel to the path of the wrapping material through the application region, the gaseous flow may be directed at an angle towards or alternatively away from the wrapping material.

As described above, the applicator is configured such that in use, a force acts on additive entrained in the gaseous flow causing said additive to be diverted towards the wrapping material. However, the term “diverted towards” should not be interpreted to imply that the additive was not moving towards the wrapping material prior to being diverted. Indeed, optionally, the additive is carried towards the wrapping material by the gaseous flow prior to being diverted by said force so that the additive takes a shorter path to the wrapping material than it would if it were not diverted.

Many other modifications and variations will be evident to those skilled in the art, that fall within the scope of the following claims:

1. An applicator operable to apply an additive to a smoking article wrapping material, comprising:
a conveyance mechanism for conveying wrapping material along a path; and
an inlet to receive a gaseous flow for entraining additive to be applied to the wrapping material;
an applicator being configured such that in use, additive entrained in the gaseous flow is caused to be diverted towards the wrapping material,
wherein the gaseous flow is directed such that the gaseous flow or a substantial part thereof does not impinge on the wrapping material.

2. The applicator according to claim 1, further comprising an application region in which the additive is applied to the wrapping material, wherein the wrapping material follows a substantially straight path through the application region.

3. The applicator according to claim 2, further comprising a gaseous flow directing member configured to direct the gaseous flow into the application region in a direction substantially parallel to the path of the wrapping material through the application region.

4. The applicator according to claim 2, wherein the wrapping material is conveyed along a generally horizontal path through the application region.

5. The applicator according to claim 1, wherein the additive is applied from below the wrapping material.

6. The applicator according to claim 1, wherein in use an electrostatic force acts on additive entrained in the gaseous flow, thereby causing the additive to be diverted towards the wrapping material.

7. The applicator according to claim 6, further comprising a charging unit for electrostatically charging the wrapping material.

8. The applicator as claimed in claim 1, wherein the wrapping material is a filter plugwrap paper.

9. The applicator according to claim 8 in combination with a filter rod maker, wherein the filter rod maker receives filter plugwrap paper having additive applied thereto from the applicator and makes filter rods for use in the manufacture of smoking articles, each filter rod comprising a filter plug wrapped with filter plugwrap paper, the plugwrap paper having additive attached thereto.

10. The applicator as claimed in claim 1, wherein the wrapping material is cigarette paper.

11. The applicator as claimed in claim 10 in combination with a smoking article maker, wherein the smoking article maker receives cigarette paper having additive applied thereto from the applicator and makes smoking articles, each smoking article comprising a tobacco rod wrapped with cigarette paper, the cigarette paper having additive attached thereto.

12. The applicator according to claim 1, wherein the additive is a granular additive.

13. The applicator according to claim 12, wherein the granular additive comprises charcoal.

14. The applicator according to claim 1, wherein the additive comprises heavier and lighter additive particles and further comprising:
a channel for the gaseous flow having the particles entrained therein, adapted such that flows of heavier and lighter particles are brought towards one another prior to application of the additive to the wrapping material.

15. The applicator according to claim 14, wherein the channel comprises:
a first substantially straight channel portion making a first angle with the horizontal;
a second substantially straight channel portion making a second angle with the horizontal, the second angle being smaller than the first angle;
wherein additive leaving the first channel portion passes at least partially through the second channel portion, the flows of heavier and lighter particles being brought towards one another after the additive leaves the first channel portion.

16. The applicator according to claim 15, further comprising a curved channel portion between the first channel and the second channel portion, wherein the flows of heavier and lighter particles are brought towards one another in the curved channel portion.

17. The applicator according to claim 15, wherein the flows of heavier and lighter particles are brought towards one another in the second channel portion.

18. The applicator according to claim 15, wherein the flows of heavier and lighter particles are brought towards one another so as to become substantially axially aligned in the channel prior to application of the additive to the wrapping material.

19. The applicator according to claim 1, comprising a channel for gaseous flow having the additive entrained therein which widens prior to application of the additive to the paper so as to decrease the velocity of the additive prior to application to the wrapping material.

20. The applicator according to claim 1, wherein the additive comprises charcoal particles having sizes between about 0.18 mm and about 1.68 mm.

21. The applicator according to claim 1, wherein the paper is conveyed at a speed of between 0.8 and 8.3 meters per second.

22. The applicator according to claim 21, wherein the paper is conveyed at a speed of between 2.5 and 8.3 meters per second.

23. The applicator according to claim 1, wherein the gaseous flow has velocity between 8.5 m/s and 36.5 m/s.

24. A method of applying an additive to a smoking article wrapping material, comprising:
conveying wrapping material along a path;
receiving a gaseous flow for entraining additive;
diverting additive entrained in the gaseous flow towards the wrapping material,
wherein the gaseous flow is directed such that the gaseous flow or a substantial pert thereof does not impinge on the wrapping material.

25. The method according to claim 24, wherein the wrapping material follows a substantially straight path though an application region in which the additive is applied to the wrapping material.

26. The method according to claim 25, wherein the gaseous flow is directed into the application region in a direction substantially parallel to the path of the wrapping material through the application region.

27. The method according to claim 25, wherein the additive is applied from below the wrapping material.

28. The method according to claim 24, wherein an electrostatic force acts on additive entrained in the gaseous flow, thereby causing the additive to be diverted towards the wrapping material.
